(19) United States
(12) Patent Application Publication
(10) Pub. No.: US 2010/0260691 A1
(43) Pub. Date: Oct. 14, 2010

(54) Aqueous compositions containing a hydrophobic material

(76) Inventors: Kolazi S. Narayanan, Wayne, NJ (US); Domingo Jon, New York, NY (US); Jayanti Patel, Elmwood Park, NJ (US); Karen Winkowski, Springfield, NJ (US)

Correspondence Address: INTERNATIONAL SPECIALTY PRODUCTS;WILLIAM J. DAVIS, ESQ., 1361 ALPS ROAD, WAYNE, NJ, 07470, US

(21) Appl. No.: 11/803,108

(22) Filed: May 11, 2007

Related U.S. Application Data
(63) Continuation-in-part of application No. 11/496,599, filed on Jul. 31, 2006.

(51) Int. Cl. A01N 25/02; A01N 31/14; A01N 37/52; A01N 31/08; A01N 65/00

(52) U.S. Cl. 424/49; 514/721; 514/635; 514/731; 514/737; 424/770

(57) ABSTRACT

An aqueous composition containing a hydrophobic material, and, more particularly, a water soluble matrix of a water soluble polymer and a water soluble surfactant, in the form of a complex, for stabilizing the hydrophobic material, as a nanoparticulate dispersion or emulsion. A delivery system for delivering bioactive hydrophobic materials as an aqueous nanoparticle dispersion of a water soluble matrix of polymer and a surfactant.

### CROSS REFERENCE TO RELATED APPLICATION

This application is a continuation-in-part of U.S. application Ser. No. 11/496,599 filed Jul. 31, 2006, the contents of which are hereby incorporated by reference.

### BACKGROUND OF THE INVENTION

This invention relates to aqueous compositions containing a hydrophobic material, and, more particularly, to a water soluble matrix of a water soluble polymer and a water soluble surfactant, in the form of a complex, for stabilizing the hydrophobic material, as a nanoparticulate dispersion or emulsion. The present invention also relates to solid compositions comprising a water soluble matrix of a water soluble polymer and a water soluble surfactant, in the form of a complex, for stabilizing a hydrophobic material in the solid composition.

Aqueous compositions of hydrophobic materials usually require high levels of emulsifiers or solvents to formulate stable systems suitable for producing functional compositions for applying or delivering the hydrophobic material under various usage conditions. For example, most disinfectants such as phenolic based disinfectants are formulated in solvent systems containing alcohols. These compositions are not preferred because of issues relating to flammability, VOC's, and long term stability.

### SUMMARY OF THE INVENTION

Aqueous and solid compositions containing a hydrophobic material are described herein. The compositions include a water soluble matrix of a water soluble polymer and a water soluble surfactant. The matrix is in the form of a complex that stabilizes the hydrophobic material in the composition as a dispersion or emulsion wherein the hydrophobic material is present as particles in the nanoparticle range. In accordance with certain embodiments of the present invention, the compositions exhibit visual clarity and can be diluted to form use compositions of various concentrations of the hydrophobic material.

In accordance with particular embodiments, the present invention relates to a delivery system for hydrophobic materials which includes a water soluble matrix of a polymer and a surfactant. The water soluble matrix may be in the form of a complex. The delivery system in accordance with this aspect of the invention includes a water soluble nanoparticulate dispersion/microemulsion of the hydrophobic material in the defined matrix.

A typical delivery system may include an active material such as triclosan as antibacterial in a mouthwash formulation, a toothpaste, a shampoo, or in a drug tablet.

Use compositions in accordance with certain aspects of the invention may be formulated for any number of uses such as water purification, cleaning composition or for wound dressing.

One example of a typical formulation comprises, by weight, a water clear composition of 3% triclosan, 3% PVP K-30 and 10.5% sodium dodecylsulfate (SDS). In accordance with particular embodiments of the present invention the polymer and surfactant form a complex which can solubilize or stabilize the hydrophobic material in water even below the critical micellular concentration (cmc) of the surfactant itself.

### BRIEF DESCRIPTION OF THE DRAWINGS

FIG. 1 is a graph of surface tension as a function of the concentration of surfactant illustrating the shift of the critical micelle concentration to a lower concentration level of the surfactant in the presence of a polymer in accordance with certain aspects of the present invention;

FIG. 2 is a triangular phase diagram illustrating a method for determining optimum concentrations for a surfactant-polymer system in accordance with a particular aspect of the invention;

FIG. 3 illustrates the tie-line for dilutions of a 4.2% Triclosan concentrate with SDS and PVP compared with a 3% concentrate with SDS alone;

FIG. 4 illustrates the increased effective activity range obtained by using a combination of PVP and SDS as compared to SDS alone;

FIG. 5 is a graph of viscosity as a function of percent solids for different ratios of surfactant and polymer; and

FIG. 6 is a graph of viscosity as a function of percent solids for different ratios of surfactant and polymer in the presence of parachlorometaxylenol (PCMX).

### DETAILED DESCRIPTION OF THE INVENTION

The present invention relates to aqueous compositions containing hydrophobic materials in the form of a nanodispersion or nanoemulsion. The hydrophobic material is stabilized in the aqueous composition such that concentrates of the hydrophobic material can be formed and used for formulation of diluted use solutions that are optically clear. The compositions also contain a matrix of a water soluble polymer and a water soluble surfactant in the form of a complex. The term “complex” is used broadly to refer to a surfactant-polymer combination wherein the surfactant and polymer interact to provide a lower surface tension than either one of the components alone. Although not wishing to be bound by theory, it is theorized that the polymer-surfactant complex functions to stabilize the hydrophobic material in the composition. The stable nanodispersion or nanoemulsion can provide a solvent-free or solvent reduced system for delivering the hydrophobic material.

The present invention further relates to solid compositions containing a hydrophobic material and a matrix of a water soluble polymer and a water soluble surfactant in the form of a complex.

As used herein, the term “substantially free” is meant to indicate that a material can be present in an incidental amount or that a particular occurrence or reaction only takes place to an insignificant extent, which does not affect desired properties. In other words, the material is not intentionally added to an indicated composition, but may be present at minor or inconsequential levels, for example, because it was carried over as an impurity as part of an intended composition component.

As used herein, the term “effective amount” refers to that amount of a composition necessary to bring about a desired result, such as, for example, the amount needed obtain a desired viscosity in an aqueous system.

As used herein, the term “polymer” is meant to encompass oligomer, and includes, without limitation, homopolymers, copolymers, terpolymers, etc. The polymers described herein can also be linear, branched and/or crosslinked polymers.

As used herein, the term “water-soluble,” when used in relation to polymers and polymer complexes, refers to polymers and polymer complexes that form a solution in water that is free of insoluble polymer particles. The determination that a solution is free of insoluble polymer particles can be made using conventional light scattering techniques or by passing the solution through a sufficiently fine filter screen capable of capturing insoluble polymer particles. As a non-limiting example, an aqueous solution containing 5 percent by weight of a polymer can be prepared and poured through a U.S. Standard Sieve No. 100 (150μ), and no particles are left on the screen. Alternatively, the turbidity of an aqueous solution containing 2.5 percent by weight of a polymer at a pH of from 5-9, may be measured using a turbidimeter or nephelometer. A reading of less than 20 nephelometric turbidity units (NTU) indicates the water-solubility of the polymer or polymer complex.

The hydrophobic materials that can be used in the present invention are not particularly limited. Hydrophobic materials are substantially insoluble in water. By the term “substantially insoluble”, it is meant that for all practical purposes, the solubility of the compound in water is insufficient to make the compound practicably usable without some modification either to increase its solubility or dispersability in water, so as to increase the compound's bioavailability or avoid the use of excessively large volumes of solvent. Substantially water insoluble materials usually include those having a solubility of less than 1 gram per liter of water at room temperature conditions.

The hydrophobic material may be a water-insoluble organic compound such as a biocide, fungicide, bactericide, insecticide, herbicide, algicide, disinfectant, light stabilizer, UV absorber, hydrocarbon, radical scavenger, synthetic resin, and/or natural wax compound. More specifically, the hydrophobic material may be a bioactive material selected from active ingredients such as a phenolics, chlorophenoxy chlorophenol/Nitrogenous compounds, iodophors, esters/paraben and natural products.

Typical “substantially insoluble” biocides include:

Iodopropargyl butyl carbamate (IPBC), Benzisothiazolone (BIT), Propiconazole, N(trichloromethylthio)pthalimide, methyl benzimidazol-2-yl carbamate, tetrachloroisophalonitrile, 2-n-octyl-3-isothiazolone, Dibromonitriloproprianamide (DBNPA), 2-(thiocyanomethylthio)benzothiazole (TCMTB), Tebuconazole, Tributyl tin benzoate, Parabens, 2,5-dimethyl-N-cyclohexyl-N-methoxy-3-furan carboxamide, 5-Ethoxy-3-trichloromethyl-1,2,4 thiadiazole, 3-(2-methyl piperidino) propyl 3,4-dichlorobenzoate, N,N′-(1,4-piperazinediyl bis(2,2,2-trichloro) ethylidene)bis formamide, Tetramethyl thiuram disulfide, O-Ethyl-S,S,diphenyl-dithiophosphate, 5,10-dihydro-5,10-dioxo naphtho (2,3,9)-p-dithiin-2,3-dicarbonitrile,α-2-[(4-chlorophenyl)ethyl]-α-(1,1-dimethyl ethyl)-1H-1,2,4-triazole-1-ethanol 3-(3,4-dichlorophenyl)1,1 dimethylurea, N-tridecyl-2,6-dimethylmorpholine and 4-N-dodecyl-2,6-dimethylmorpholine. Specific examples of particularly useful bioactive materials include triclosan, chlorhexidine, iodopropargyl butyl carbamate (IPBC), orthophenyl phenol, parachlorometaxylenol (PCMX), parachloro ortho benzyl phenol, tertiary amyl phenol, pine oil, mixed phenol disinfectants, mixed phenol and quats.

Examples of UV absorbers include, without limitation, avobenzone, benzophenone-3, p-Aminobenzoic acid (PABA), Camphor benzalkonium methosulfate, Homosalate, Phenylbenzimidazole sulfonic acid, Terephthalidene dicamphor sulfonic acid, Benzylidene camphor sulfonic acid, Octocrylene, Polyacrylamidomethyl benzylidene camphor, Ethylhexyl methoxycinnamate, PEG-25 PABA, Isoamyl p-methoxycinnamate, Ethylhexyl triazone, Drometrizole trisiloxane, Diethylhexyl butamido triazone, 4-Methylbenzylidene camphor, 3-Benzylidene camphor, Ethylhexyl salicylate, Ethylhexyl dimethyl PABA, Benzophenone-4, Benzophenone-5, Methylene bis-benztriazolyl tetramethylbutylphenol, Disodium phenyl dibenzimidazole tetrasulfonate, Bis-ethylhexyloxyphenol methoxyphenol triazine, and Polysilicone-15.

The hydrophobic material may be present in the aqueous or solid composition at a wide range of concentrations depending on the material and the use of the composition. For concentrates, the hydrophobic material will typically be present in an amount by weight of about 1% to about 40%, more particularly from about 1.5% to about 30% and in accordance with certain embodiments from about 2% to about 20% of the concentrate. For use compositions, the hydrophobic material will typically be present in an amount by weight of about 1 ppm to about 10000 ppm, more particularly from about 2 ppm to about 5000 ppm and in accordance with certain embodiments from about 5 ppm to about 4000 ppm of the diluted use composition.

The hydrophobic material is present in the composition as an emulsion or a dispersion. The particle size of the hydrophobic material in the composition typically falls within the range of from about 5 to 1000 nm, more particularly from about 5 to 500 nm, still more particularly from about 10 to 100 nm and in accordance with certain embodiments from about 10 to 30 nm. Particle size refers to average particle radius and can be determined using dynamic light scattering techniques and equipment known to those of skill in the art. The compositions in accordance with certain aspects of the invention are visually clear due primarily to the small particle size of the hydrophobic material. Optical clarity can be measured using a turbidimeter or nephelometer. A reading of less than 200 nephelometric turbidity units (NTU), more particularly less than about 100 NTU at 25° C. typically indicates that the hydrophobic material is stable in the solution.

Water soluble polymers useful in the present invention include those capable of forming a complex with a water soluble surfactant wherein the complex facilitates formation of a nanoemulsion or nanodispersion of the hydrophobic material in the composition.

Examples of typical polymer species include but are not limited to:

Lactam/Pyrrolidone based polymers
Polyvinyl pyrrolidone/polyvinyl caprolactam
Pyrrolidone co-polymers
   Vinyl acetate—Vinylpyrrolidone co-polymers
   Alkylated graft Vinylpyrrolidone co-polymers
   Dimethylaminoethylmethacrylate Vinylpyrrolidone co-polymers
   Acrylic acid/ester/salt-Vinylpyrrolidone co-polymers
   Vinylpyrrolidone/Vinyl caprolactam co-polymers

Alpha olefin maleic acid/ester co-polymers
Styrene maleic acid co-polymers
Alkyl vinyl ether-maleic acid/ester/salts co-polymers

Alpha olefin Polymers: Polyacrylates/polyvinyl derivatives
Poly alkylacrylate/alkylacrylic esters/amides/salts
Polyvinyl alcohol/acetates

Natural polymers
Cellulosic derivatives
Modified Starch
Alginates

The water soluble polymer typically is used in an amount sufficient to form a complex with the surfactant and interact with the surfactant to lower the cmc of the system as compared to a system without the polymer. The methodology for selecting a polymer and determining the appropriate amount for a particular system is described in more detail below. For certain embodiments, the water soluble polymer will be present in an amount by weight percent of about 0.1% to about 40%, more particularly from about 0.15% to about 30% and in accordance with certain embodiments from about 0.2% to about 20% of the concentrate. For use compositions, the water soluble polymer will typically be present in an amount by weight of about 1 ppm to about 10,000 ppm, more particularly from about 2 ppm to about 5,000 ppm and in accordance with certain embodiments from about 5 ppm to about 4,000 ppm of the diluted use composition.

The surfactant suitable for use in the systems described herein may be selected from anionic, non-ionic, amphoteric, cationic and mixtures thereof. The following types of surfactants are representative of the surfactants that can be used:

a. Anionic Surfactants. Anionic surfactants are particularly useful in accordance with certain embodiments of the present invention. Surfactants of the anionic type that may be useful include:

1. Sulfonates and Sulfates. Suitable anionic surfactants include sulfonates and sulfates such as alkyl sulfates, alkylether sulfates, alkyl sulfonates, alkylether sulfonates, alkylbenzene sulfonates, alkylbenzene ether sulfates, alkylsulfoacetates, secondary alkane sulfonates, secondary alkylsulfates and the like.

Examples include, but are not limited to: alkyl ether sulfonates such as lauryl ether sulfates such as POLYSTEP B12 (n=3 4, M=sodium) and B22 (n=12, M=ammonium) available from Stepan Company, Northfield, Ill. and sodium methyl taurate (available under the trade designation NIKKOL CMT30 from Nikko Chemicals Co., Tokyo, Japan); secondary alkane sulfonates such as Hostapur SAS which is a Sodium (C14 C17) secondary alkane sulfonates (alpha-olefin sulfonates) available from Clariant Corp., Charlotte, N.C.; methyl-2-sulfoalkyl esters such as sodium methyl-2-sulfo(C12 16) ester and disodium 2-sulfo(C12 C16) fatty acid available from Stepan Company under the trade designation ALPHASTE PC-48; alkylsulfoacetates and alkylsulfosuccinates available as sodium laurylsulfoacetate (under the trade designation LANTHANOL LAL) and disodiumlaurethsulfosuccinate (STEPANMILD SL3), both from Stepan Company; alkylsulfates such as ammoniumlauryl sulfate commercially available under the trade designation STEPANOL AM from Stepan Company.

2. Phosphates and Phosponates. Suitable anionic surfactants also include phosphates such as alkyl phosphates, alkylether phosphates, aralkylphosphates, and aralkylether phosphates.

Examples include a mixture of mono-, di- and tri-(alkyltetraglycolether)-o-phosphoric acid esters generally referred to as trilaureth-4-phosphate commercially available under the trade designation HOSTAPHAT 340KL from Clariant Corp., as well as PPG-5 ceteth 10 phosphate available under the trade designation CRODAPHOS SG from Croda Inc., Parsipanny, N.J.

3. Amine Oxides. Suitable anionic surfactants also include amine oxides.

Examples of amine oxide surfactants include those commercially available under the trade designations AMMONYX LO, LMDO, and CO, which are lauryldimethylamine oxide, laurylamidopropyldimethylamine oxide, and cetyl amine oxide, all from Stepan Company.

b. Amphoteric Surfactants. Surfactants of the amphoteric type include surfactants having tertiary amine groups which may be protonated as well as quaternary amine containing zwitterionic surfactants. Those that may be useful include:

1. Ammonium Carboxylate Amphoterics.

Examples of such amphoteric surfactants include, but are not limited to: certain betaines such as cocobetaine and cocamidopropyl betaine (commercially available under the trade designations MACKAM CB-35 and MACKAM L from McIntyre Group Ltd., University Park, Ill.); monoacetates such as sodium lauroamphoacetate; diacetates such as disodium lauroamphoacetate; amino- and alkylamino-propionates such as lauraminopropionic acid (commercially available under the trade designations MACKAM 1L, MACKAM 2L, and MACKAM 151L, respectively, from McIntyre Group Ltd.).

2. Ammonium Sulfonate Amphoterics. This class of amphoteric surfactants are often referred to as “sultaines” or “sulfobetaines”. Examples include cocamidopropylhydroxysultaine (commercially available as MACKAM 50-SB from McIntyre Group Ltd.).

c. Nonionic Surfactants.

Surfactants of the nonionic type that may be particularly useful include:

1. Polyethylene oxide extended sorbitan monoalkylates (i.e., Polysorbates).

2. Polyalkoxylated alkanols. Surfactants such as those commercially available under the trade designation BRIJ from ICI Specialty Chemicals, Wilmington, Del. having an HLB of at least about 14 may be useful.

3. Polyalkoxylated alkylphenols. Examples of surfactants of this type include polyethoxylated octyl or nonyl phenols having HLB values of at least about 14, which are commercially available under the trade designations ICONOL and TRITON, from BASF Corp., Performance Chemicals Div., Mt. Olive, N.J. and Union Carbide Corp., Danbury, Conn., respectively. Examples include TRITON X100 (an octyl phenol having 15 moles of ethylene oxide available from Union Carbide Corp., Danbury, Conn.) and ICONOL NP70 and NP40 (nonyl phenol having 40 and 70 moles of ethylene oxide units, respectively, available from BASF Corp., Performance Chemicals Div., Mt. Olive, N.J.). Sulfated and phosphated derivatives of these surfactants may also be useful. Examples of such derivatives include ammonium nonoxynol-4-sulfate, which is commercially available under the trade designation RHODAPEX CO-436 from Rhodia, Dayton, N.J.

4. Polaxamers. Surfactants based on block copolymers of ethylene oxide (EO) and propylene oxide (PO) may also be effective. Both EO-PO-EO blocks and PO-EO-PO blocks are expected to work well as long as the HLB is at least about 14, and preferably at least about 16. Such surfactants are commercially available under the trade designations PLURONIC and TETRONIC from BASF Corp., Performance Chemicals Div., Mt. Olive, N.J. It is noted that the PLURONIC surfactants from BASF have reported HLB values that are calculated differently than described above. In such situation, the HLB values reported by BASF should be used. For example, preferred PLURONIC surfactants are L-64 and F-127, which have HLBs of 15 and 22, respectively.

5. Polyalkoxylated esters. Polyalkoxylated glycols such as ethylene glycol, propylene glycol, glycerol, and the like may be partially or completely esterified, i.e., one or more alcohols may be esterified, with a (C8 C22)alkyl carboxylic acid. Such polyethoxylated esters having an HLB of at least about 14, and preferably at least about 16, may be suitable for use in compositions of the present invention.

6. Alkyl Polyglucosides. Alkyl polyglucosides may also be used. Examples include glucopon 425, which has a (C8 C16)alkyl chain length with an average chain length of 10.3 carbons and 1 4 glucose units.

d. Cationic Surfactants. Surfactants of the cationic type that may be useful include alkyl and aryl amine alkoxylates, alkoxylated ethylene diamine derivatives and alkyl/aryl/aryalkyl amine oxides.

Combinations of various surfactants can be used if desired.

Particularly useful anionic surfactants include alkyl esters of inorganic or organic acids with or without polyalkoxylated group included. These include the sulfonates, sulfates, phosphates, and phosphonates.

The presence of the water soluble polymer in the matrix facilitates formation of a polymer-surfactant complex which can lead to a nanoemulsion or nanodispersion of the hydrophobic material even with low amounts of surfactant present in the composition. Both the use of a low level of surfactant and the complexing polymer provides a substantially irritant-free composition.

The amount of surfactant to form a nanoemulsion or nanodispersion of the hydrophobic material in water depends on the material and concentration of the material. Typically, the higher the hydrophobic material concentration, the higher the amount of surfactant to be added.

For compositions of the polymer-surfactant-complex and hydrophobic materials the weight ratio of hydrophobic material to surfactant-polymer complex is about 1:80 to 5:0.5, preferably about 1:0.2 to 1:40. The weight ratio of hydrophobic material to surfactant suitably is about 1:40 to 2:1, more particularly about 1:10 to 5:1, preferably about 1:8 to 1:1 and in certain embodiments about 1:5 to 1:3. The weight ratio of hydrophobic material to polymer suitably may be about 1:10 to 5:0.5, more particularly about 1:0.2 to 1:2. For concentrates, the hydrophobic material will typically be present in an amount by weight percent of about 1% to about 40%, more particularly from about 1.5% to about 30% and in accordance with certain embodiments from about 2% to about 20% of the concentrate. The use level of hydrophobic material suitably is about 10 ppm to about 10,000 ppm, more particularly from about 20 ppm to about 5000 ppm and in accordance with certain embodiments from about 50 ppm to about 4000 ppm of the diluted use composition. Moreover, in some cases, the concentrate can also function as a use composition. Accordingly, the amounts by weight for the materials in either the concentrate or use composition can overlap. Weight ratio of the surfactant to the polymer is typically: 20:1 to 1:20, preferably 10:1 to 1:10.

In accordance with particular embodiments of the invention, the concentrate and the diluted use composition consist of the hydrophobic material, the polymer-surfactant complex and water.

The compositions of the present invention may also include other materials and components to modify or provide certain properties to the concentrate and/or the final use solutions. Examples of other materials that can be added include without limitation flavors, colors, thickeners, defoamers, additional surfactants, polymers or active ingredients. Furthermore, although some embodiments of the present invention are directed to solvent-free or solvent-reduced formulations, the compositions in accordance with other embodiments may include conventional solvents for known functionalities.

The present invention provides concentrates and use compositions that can be used in a number of applications. For example, the compositions may be formulated as ready-to-use sprayable aqueous solutions of the hydrophobic material such as a disinfectant. The aqueous solutions could be formulated for being dispensed from a pen or marker. Aqueous compositions containing disinfectants could be used for personal disinfectant/Aircraft disinfection/Hospital, sick bed disinfection etc. Sprayable disinfecting agent for harvested and processed vegetables can be prepared using the concentrates of the present invention as a carrier for the disinfectant. The compositions described herein can be formulated to provide a method for treating seeds so as to disinfect them. The solutions can be used to disinfect work environments or livestock areas such as poultry farms.

The compositions described herein can also be formulated as personal care compositions, cosmetics, pharmaceuticals, agricultural or industrial compositions containing hydrophobic active materials without the need for solvents. For example, water-based mouth wash with no alcohol or optional addition of alcohol can be produced. To produce the finished product the compositions can be formulated to include functional or aesthetic components such as whitening agents, flavors, colors, thickeners, defoamers etc.

Disinfecting/biocidal composition from natural resources can be formulated without the need for solvent or high levels of solvent. The compositions may be useful as carriers for providing biocidal protection for coatings like paints, etc. These would be particularly useful in water based systems.

The compositions can be used in the compounding of pharmaceuticals. The methods described herein can be used to prepare concentrates of the active that are easier to handle and process into finished dosage forms. The dosage forms can provide modified release profiles in accordance with standard techniques. For example a sustained release profile can be obtained via adsorption on substrates. Specific examples of pharmaceutical active ingredients include, without limitation, Furosemide, Lovastatin, Clarithromycin, Diclofenac, Famotidine, Carbamaxepine, Dipyridamole, Chlorthiazide, Spironolactone, Dilantin, Imipranine, Melfloquine, Cyclosporine, Glyburide, and Nimodipine.

The compositions can be prepared and used in solid form. For example, a disinfecting solid can be prepared which additionally contains peroxides like percarbonates like sodium percarbonate, PVP, hydrogen peroxide, urea-hydrogen peroxide etc.

The compositions can also be formulated as a gel or aerosol. For example a gel formulation could be used to provide as sprayable bandage by compounding the active with alginates and other gel forming bioadhesive media. Aerosols could be prepared that are water-based and avoid the use of solvents.

Certain compositions in accordance with particular aspects of the present invention provide reduced irritation from the surfactant arising from a) reduced levels of surfactant used and b) surfactant complexing/binding with the non-irritating polymer.

Further, presence of the polymer could also reduce the viscosity of the concentrate as compared to a control sample of the concentrate without the polymer. The lower viscosity concentrate facilitates diluting, handling, storing and shipping of the concentrate.

The following description details a methodology that can be used to identify a suitable combination of components and their relative amounts to develop formulations in accordance with particular embodiments of the present invention. One of ordinary skill in the art appreciates the factors that are typically involved in selecting an appropriate surfactant for a particular active or material based on chemical structure and properties. Some experimentation may be required to determine the optimum combination of materials in the appropriate concentrations.

Step 1: Identify Surfactant-Polymer Combination

Choice of Surfactants: Surfactant should be such that an aqueous solution of the surfactant should be able to solubilize (via micelle formation) certain amount of the active ingredient in water.

The nature of an effective surfactant system would depend upon the structure and the solubility characteristics of the active ingredient and structure of the surfactant system.

Typically the concentration of the surfactant should be at least equal to or greater than the critical micelle concentration (CMC). In some cases 2-3×CMC of the surfactant may be necessary to solubilize a given weight of the active ingredient.

Examples of generic surfactants include without limitation:
Anionic
   [symbol] Alkyl sulfate
   [symbol] Alkyl sulfonate
   [symbol] Alkylester sulfonate/carboxylate/sulfate
   [symbol] Aryl/arylalkyl sulfate/sulfonate phosphate/phosphonate
   [symbol] Alkyl/aryl sulfosuccinate/sarcosinate
   [symbol] Alkyl/aryl carboxylate
Non-Ionic
   [symbol] Alcohol ethoxylate/propoxylate
   [symbol] Aryl/alkyl ether alkoxylate
   [symbol] Oxirane/methyl oxirane co-polymers
   [symbol] Alkyl ester alkoxylates
   [symbol] Alkoxylated polyesters
   [symbol] Alkoxylated siloxanes
   [symbol] Alkoxylated carbohydrates
Cationic
   [symbol] Alkyl/aryl amine alkoxylate
   [symbol] Alkoxylated ethylene diamine derivatives
   [symbol] Alkyl/aryl/aryalkyl amine oxide
Amphoteric
   [symbol] Betains

Choice of Polymer

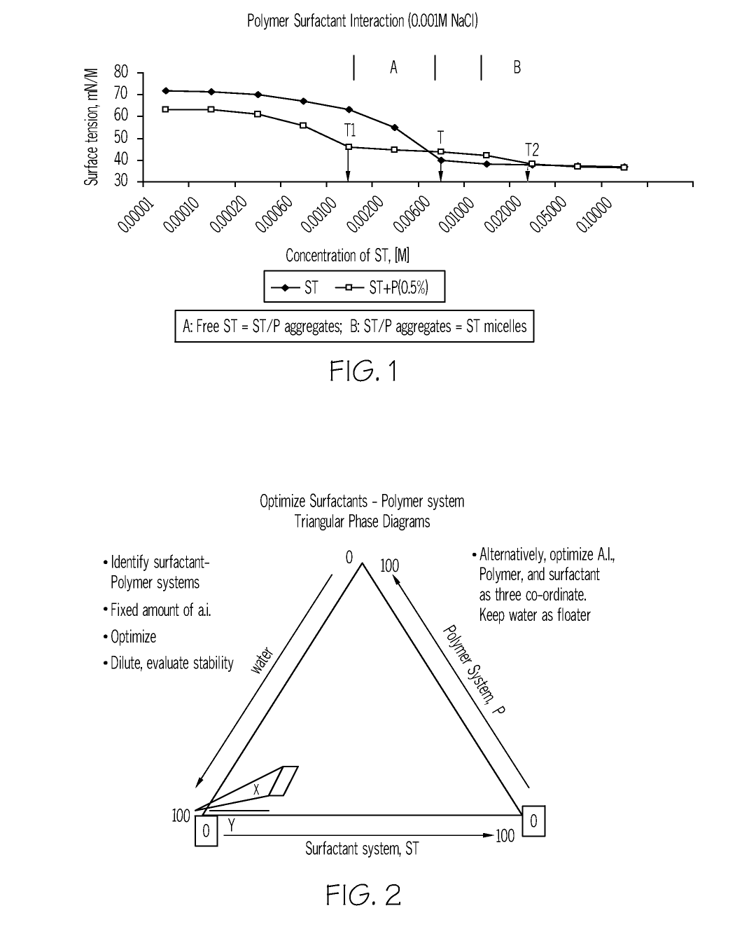

Suitable polymer is selected by first determining the surface tension concentration profile of the surfactant and evaluating the CMC. This is done by preparing standard solutions of the surfactant in water at different concentration and dilutions and measuring surface tension of the solutions and plotting the data as shown in FIG. 1. Surface tension may be measured using a typical Tensiometer [DuNuoy Tensiometer, Surface Tensiomat, Fisher with a platinum ring with a mean circumference of 6 cm, and a ring/wire radius ratio of 53.8. As an example: starting with 1% solution of a typical surfactant like SDS, serial dilutions are made by diluting appropriate amounts of the 1% stock solution and diluting to 0.5%, 0.2%, 0.1% and 0.05, 0.02, 0.01, 0.005, 0.002, by adding appropriate amounts of de-ionized water to a weighed quantity of the stock solution. FIG. 1 is a plot of concentration in moles per liter of the SDS and surface tension at 25° C. Point T shows the CMC of SDS.

The above experiment is repeated by preparing the standard solution in an aqueous solution of the test polymer. For example: all solutions of SDS is prepared in an aqueous solution containing X % polyvinyl pyrrolidone, where X=0.1, 0.2, 0.5, 1, 1.5, 2% and so on. In FIG. 1 the amount of the polymer PVP K 30 is kept at 0.5%. If a distinct interaction is present, it is detected by a shift of the CMC to a lower concentration level of the surfactant in the presence of the Polymer. Point T1 is the apparent CMC of the surfactant SDS in the presence of 0.5% of PVP. And T1 is lower than T. [Reference: Narayanan, K. S., Emulsion and Microemulsion Technology for Formulating Agrochemicals, in Proccedings from Formulation Forum, Foy, C. L., Pritchard D. W., and Beestman, G. B., Eds., Association of Formulation Chemists, 1998, 220-294. [paper presented as an invited speaker].—See FIG. 21, page 259.

At the point T1 air-water surface is saturated with surfactant molecules and polymer-surfactant complex starts to form. This process is extended till Point T2 is reached. At point T2 onwards free micelles are formed.

Various species formed and their interrelationship are summarized by mass balance equations (1) through (3).

Polymer-Surfactant Interaction—Mass Balance

nfST=(ST)nf (1);

nbST+P=P(ST)nb (2)

XT=X1+nf(KfX1)nf+nbnpXp[(KbX1)nb/{1+(KbX1)nb}] (3)
XT=Total surfactant concentration;
X1=Singly dispersed surfactant concentration
Xp=Polymer repeat unit concentration
nf, nb, and np are the aggregation number for free micelle, polymer-bound micelle and the number of binding sites per repeat unit
Kf and Kb are equilibrium constant for micelle formation and polymer binding.
If Kf>Kb; and nf, ≅nb; micellization is preferred
If Kf<Kb; and nf, ≅nb; Polymer binding is preferred
If Kf<Kb; and nf, >nb; Micellization can occur prior to polymer binding
   ST: Surfactant, P: polymer

FIG. 2 summarizes a method that can be used for optimization. Once the components are identified, optimization may be performed by preparing several mixtures of the components in different ratios and observing the phase behavior. Plot the compositions producing clear systems for concentrate and dilutions and identify regions in the triangular composition space. For a fixed amount of the hydrophobic material or active ingredient, vary the ratios of the surfactant and polymer in water. Alternately, vary the concentration of the hydrophobic material or active ingredient, polymer and surfactant in different ratio and make up to 100% in water and plot the compositions providing clear systems for the concentrate and for dilutions.

For example, Triclosan was identified as the target active ingredient. SDS was identified as the solubilizing surfactant and PVP K 30 was identified as the interacting polymer. FIG. 2 shows the optimized region marked X. In the presence of PVP a concentrate containing 4% of Triclosan, a minimum of 13% SDS and 2-4% PVP could be successfully diluted to all levels up to the solubility range at 10 ppm with water without separation. The above diluted solutions may contain fraction of the CMC of SDS, still providing homogeneous solutions. The particle size in the above systems were measured and found to be in the range 10-30 nm radius.

By comparison, a concentrate containing 3% of Triclosan with SDS alone could be prepared with 25% SDS. This concentrate could only be diluted to levels containing up to ˜0.5% SDS, which is about 3-3×CMC of SDS. Further dilutions produced precipitates of Triclosan. See region Y in FIG. 2. Y truncates at ˜0.5% SDS

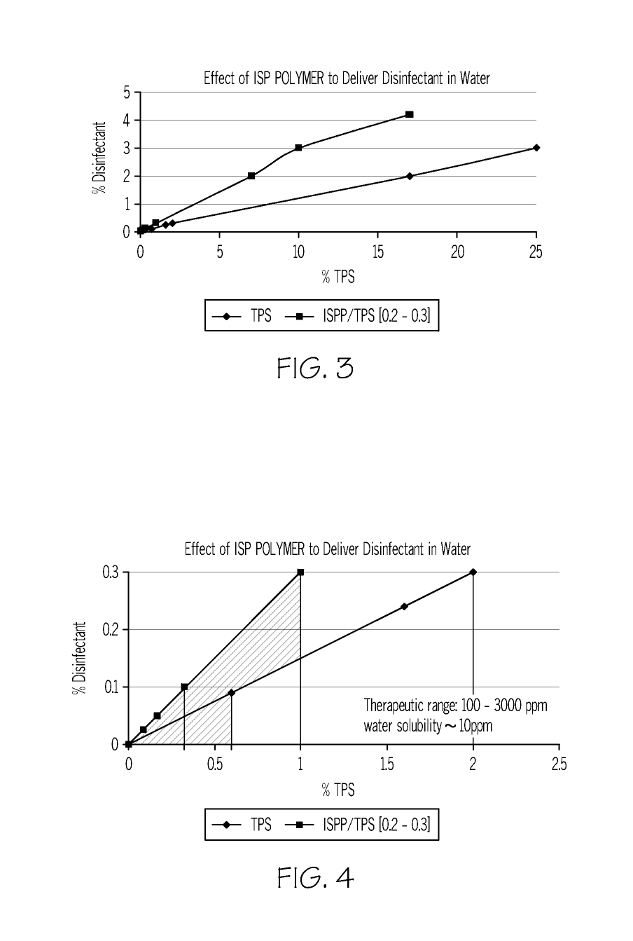

FIG. 3 shows the tie-line for dilutions of 4.2% Triclosan concentrate with SDS and PVP compared with 3% concentrate with SDS alone. Note the level of SDS required was 25% to solubilize 3% Triclosan. On the other hand in the presence PVP higher level of Triclosan at 4.2% could be solubilized with 17% SDS and PVP at 3-5%.

The effective activity range with and without PVP are shown in the FIG. 4. The composition range for Triclosan up to 0.3% to provide clear aqueous systems with PVP is shown as ‘P” in FIG. 4, whereas the composition range without the use of PVP is shown as “Q” in FIG. 4. It is clear that the therapeutic range of Triclosan (clear system in water) can be enhanced considerably by using a combination of PVP and SDS compared to SDS alone. Compare the area between the regions marked P and Q in FIG. 4. In the regions beyond Q using SDS alone, Triclosan was found to precipitate at dilutions beyond 0.4-0.5 SDS.

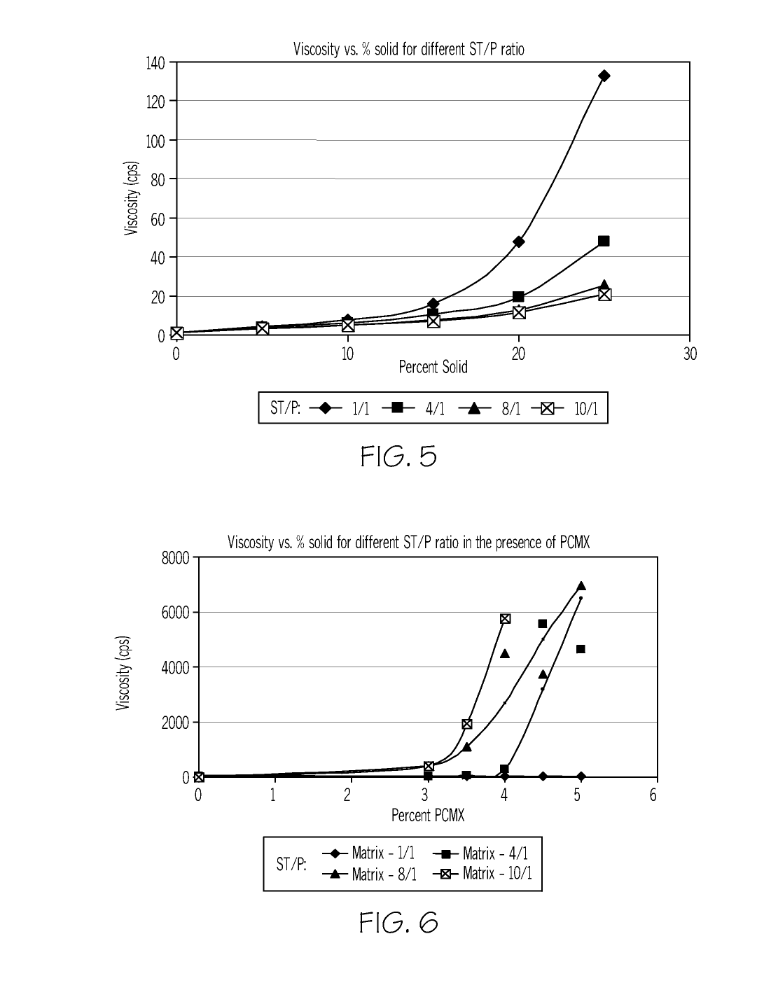

FIGS. 5 and 6 illustrate the impact of the polymer on viscosity of a concentrate without an active material and with an active material. In FIG. 5, the viscosity of a system containing surfactant and polymer increases as the percent polymer in the system increases. By contrast, FIG. 6 illustrates a concentrate containing surfactant, polymer and PCMX wherein the viscosity increases as the percent polymer decreases. Accordingly, concentrates can be prepared at lower viscosities by incorporating polymer into the system.

Although not wishing to be bound by theory, it is believed that the therapeutic activity of Triclosan or a suitable active ingredient becomes available in the presence of a polymer like PVP, for the following reason. The polymer acts like a mother ship with surfactant like SDS molecules attaching to the polymer in small clusters even below the CMC. The active ingredient can be lodged inside those clusters in the hydrophobic regions, and gets solubilized as nano-particles range. These active ingredients are available to interact with biological substrate like a bacterial surface. Different possible configurations can occur at different levels of surfactant concentrations.

The following non-limiting examples further illustrate certain aspects of the present invention.

### EXAMPLE 1

3% Triclosan was dissolved in water containing, by weight, 3% polyvinylpyrrolidone (PVP K-30) and 10% sodium dodecyl sulfate (SDS). The aqueous concentrate was diluted at 1/10, 1/30, 1/60, and 1/120 to produce optically clear, ready-to-use disinfectant compositions. Triclosan in these compositions were in the nanoparticle range.

Compositions with lower than 10% SDS or with 10% SDS in the absence of PVP did not dissolve the triclosan.

### EXAMPLE 2

A use formulation containing, by weight, 3% Triclosan, 3% PVP K-30 and 10.5% SDS was diluted with water at a weight ratio of 1/450 to a final concentration of 66 ppm Triclosan, 66 ppm PVP K-30 and 230 ppm SDS. The diluted sample remained clear without any precipitate. While the amount of SDS at this dilution is below the CMC of SDS itself, the active disinfectant, Triclosan was maintained soluble in water (above it's solubility at 10 ppm) at this low surfactant content in the presence of the polymer, PVP K-30.

### See FIGS. 2, 3, and 4.

### EXAMPLE 3

4.2% Triclosan was dissolved in water containing, by weight, 3.2% PVP K-30 and 17% SDS. The aqueous concentrate was diluted at 4.6/100 and 2.3/100 to produce optically clear, ready-to-use disinfectant compositions. Triclosan in these compositions was in the nanoparticle range.

### EXAMPLE 4

2% Triclosan was dissolved in water containing, by weight, 2% PVP K-30 and 7% SDS. The optically clear aqueous concentrate was diluted at 1/10 and 1/20 to produce optically clear, ready-to-use disinfectant compositions. Triclosan in these compositions was in the nanoparticle range.

### EXAMPLE 5

### Comparative

2% Triclosan was added to water containing, by weight, 2% PVP K-30. Triclosan remained undissolved in the aqueous concentrate.

### EXAMPLE 6

### Comparative

2% Triclosan was added to water containing, by weight, 7% SDS. The sample was heated to 60° C. for 3 days. Triclosan remained undissolved in the aqueous concentrate.

### EXAMPLE 7A

### Comparative

Minimum amount of SDS to solubilize 0.3% Triclosan in water was found to be ˜2% SDS. This concentrate was serially diluted at 3/10, 2.5/10, 2/10, 1.5/10, 1/10, 0.8/10, 0.6/10, 0.4/10 with water. All the dilutions starting from 2/10 through 0.4/10 produced cloudy solutions/separation of crystalline solid within zero-two days. Minimum amount of SDS required to solubilize 0.075%-0.09% Triclosan was ˜0.4-0.5% range SDS. See FIG. 4 (Tie-line). This corresponds to about two-three times the CMC for SDS, which was determined to be about 0.17%.

### EXAMPLE 7B

On the other hand a concentrate of Triclosan at 0.3% prepared with 1% SDS and 0.2-0.3% PVP K 30 was clear. This concentrate could be diluted at several levels as above producing optically clear compositions without any separation.

Dilutions could be made at levels of SDS far below the CMC. See FIG. 4 (Tie-line).

### EXAMPLE 8

### Triclosan-PVP K-30-Sodium Lauryl Sulfate Stability Study

Stability study of 4% Triclosan formulation: 9.68 g of a 33% aqueous solution of polyvinylpyrrolidone (PVP K-30) was added to a 100 ml stopper glass bottle, the sample was then diluted with the addition of 27.7 g of purified water and hand shaken to form a homogeneous aqueous solution. 58.7 g of Sodium Lauryl Sulfate (Stepanol WAC diluted to 25% aqueous solution with water), was added to this aqueous solution with further shaking the sample to form a premix that was clear, and homogeneous. 4 g of Triclosan was weighed and added to the above premix to form a disinfectant aqueous solution. The sample was shaken and put on a rotary mixer over the weekend, to produce a clear, homogeneous concentrate. The aqueous concentrate was diluted at dilution ratio of 7.5/100 (g/ml) with purified water obtaining a clear aqueous solution of 0.3% Triclosan. Both concentrate and diluted samples were kept in an oven at 50° C. for 4 weeks, samples were extracted at intervals of 3, 7, 15, 21 and 28 days. Concentration of Triclosan was determined by absorbance value at 282.53 nm. The absorbance was standardized by preparing a stock aqueous solution of 0.10 g Triclosan in 100 ml of IPA and diluting if further with WA at a ratio of 1/50, 1/25 and 1/12.5. Absorbance values were measured at the diluted range. The plot of Absorbance vs. concentration gave a straight line with an R square value of 1. The Triclosan aqueous concentrate was diluted twice, first 1.0 g of the concentrate was diluted to 25 ml with IPA (Solution A). Solution A was diluted further at the ratio of 0.75 g Solution A to 25 ml with IPA before measuring the concentration through absorbance. A 100% recovery was obtained for the 4% Triclosan concentrate after exposure to 50° C. for 28 days. Similarly, the diluted samples were pre-diluted at the ratio of 0.4 to 25 with WA before analysis. A 100% recovery was also obtained for the 0.3% Triclosan dilutions after exposure to 50° C. for 28 days.

### EXAMPLE 9

5.4% PCMX was dissolved in water containing, by weight, 16.5% SDS and 2.3% PVP K-30. The aqueous concentrate was diluted at 1/10, 1/20, 1/40, 1/100, and 1/450 to produce optically clear, ready-to-use disinfectant compositions. PCMX in these compositions was found to be: 10-30 nm radius, in nanoparticle range.

### EXAMPLE 10

2% PCMX was dissolved in water containing, by weight, 6% SDS and 1% PVP K-30. The aqueous concentrate was diluted at 1/10, 1/20 to produce optically clear, ready-to-use disinfectant compositions. PCMX in these compositions was found to be: 10-30 nm radius, in nanoparticle range.

### EXAMPLE 11

### Comparative

2% PCMX was added to water containing, by weight, 2% PVP K-30. PCMX remained undissolved in the aqueous concentrate.

### EXAMPLE 12

4.9% PCMX was dissolved in water containing, by weight, 13.8% SDS and 4% PVP K-30. This clear aqueous concentrate was diluted at 1/10, 1/20 to produce optically clear, ready-to-use disinfectant compositions at RT (18° C.). PCMX in these compositions was found to be in nanoparticle range.

### EXAMPLE 13

### Comparative

4.9% PCMX was added to water containing, by weight, 14.4% SDS. The sample was heated and cooled to RT (18° C.). PCMX remained Undissolved in the aqueous concentrate.

### EXAMPLE 14

### PCMX-PVP K-30-Sodium Lauryl Sulfate Stability Study

Stability study of 5% PCMX formulation: 6 g of a 33% aqueous solution of polyvinylpyrrolidone K-30) was added to a 100 ml stopper glass bottle, the sample was then diluted with the addition of 29.1 g of purified water and hand shaken to form a homogeneous aqueous solution. 59.91 g of Sodium Lauryl Sulfate (Stepanol WAC diluted to 25% aqueous solution with water), was added to this aqueous solution with further shaking the sample to form a premix that was clear, and homogeneous. 5 g of PCMX was weighed and added to the above premix to form a disinfectant aqueous solution. The sample was shaken and put on a rotary mixer overnight, to produce a clear, homogeneous concentrate. The aqueous concentrate was diluted at dilution ratio of 5/100 (g/ml) with purified water obtaining a clear aqueous solution of 0.25% PCMX. Both concentrate and diluted samples were kept in an oven at 50° C. for 4 weeks, samples were extracted at intervals of 1, 2, 5, 7, 14, 21 and 28 days. Concentration of PCMX was determined by absorbance value at 280.96 nm. The absorbance was standardized by preparing a stock aqueous solution of 0.107 g PCMX in 100 ml of IPA and diluting if further with IPA at a ratio of 1/100, 1/50 and 1/25. Absorbance values were measured at the diluted range. The plot of Absorbance vs. concentration gave a straight line with an R square value of 1. 0.055 g of PCMX aqueous concentrate was further diluted to 100 ml with IPA before measuring the concentration through absorbance. A 100% recovery was obtained for the 5% PCMX concentrate after exposure to 50° C. for 28 days. Similarly, the diluted samples were pre-diluted at the ratio of 1/100 with IPA before analysis. A 100% recovery was also obtained for the 0.25% PCMX dilutions after exposure to 50° C. for 28 days.

### EXAMPLE 15

### Biological Activity

2% PCMX was dissolved in water containing, by weight, 6% SDS and 1% PVP K-30. The aqueous concentrate was diluted at 1/10, 1/20 to produce optically clear, ready-to-use disinfectant compositions. PCMX in these compositions was found to be in the nanoparticle range.

Biological Activity

The formulation described above was diluted in DI water to contain 1,000 ppm of PCMX. Antimicrobial activity was demonstrated against Pseudomonas aeruginosa (ATCC 10145) and Bacillus subtilis (ATCC 27328). One hundred microliters of an overnight culture of each bacterial cell suspension were inoculated into the diluted sample to a final concentration of about 10⁷ CFU/ml. The same bacterial suspension was also added to DI water to serve as a control. After 5 min. incubation time at room temperature, the samples were serially diluted in Modified Letheen broth and plated onto modified Letheen Agar. Plates were incubated at 32° C. for 24 hours and bacterial growth enumerated. Log reduction was calculated based on the log difference in bacterial counts between the control sample (no PCMX) and PCMX containing sample. The results are presented in the following table:

| | P. aeruginosa | | B. subtilis | |
|---|---|---|---|---|
| | | Log | | Log |
| Treatment | CFU/ml | Reduction | CFU/ml | reduction. |
| DI water | 9.8 × 10⁷ | — | 4.0 × 10⁷ | — |
| 1,000 PPM | <1 × 10² | 6 | 3.3 × 10³ | 4 |
| PCMX | | | | |

Particle Size Distribution:

The aqueous concentrate of PCMX at 4.8% and the dilutions at 0.24% and 0.12% were analyzed by Dynamic Light Scattering and were found to have the particle size centered around 10-25 nm radius in all the samples.

### EXAMPLE 16

### PCMX-PVP K-30-Sodium Lauryl Sulfate-Biological Activity Examples

Preparation of 4.8% PCMX formulation: 3 g of a 33% aqueous solution of polyvinylpyrrolidone (PVP K-30) was added to a 50 ml stopper glass bottle, the sample was then diluted with the addition of 18.7 g of purified water and hand shaken to form a homogeneous aqueous solution. 25.8 g of sodium lauryl sulfate (Stepanol WAC, (29% aqueous solution, from Stepan)) was added to this aqueous solution with further shaking the sample to form a premix that was clear, and homogeneous. 1.81 g of PCMX was weighed and added in a 50 ml container. 35.7 g of the above premix was then added to the 50 ml container with PCMX to form a disinfectant aqueous solution. The sample was shaken and put on a rotary mixer overnight, to produce a clear, homogeneous concentrate. The aqueous concentrate was diluted at dilution ratio of 1/20.2 and 1/40.4 with purified water producing compositions of PCMX at 0.24% (label claim) and 0.12% (half of label claim). These dilutions were screened for biological activity against three different species of bacteria at an outside testing facility. Time kill study showed >5 Log reduction of the following species tested: Escherichia coli, Staphylococcus aureus, and Salmonella, with centering time at 5 minutes, 10 minutes and 15 minutes.

### EXAMPLE 17

5.4% 2-phenylphenol was dissolved in water containing, by weight, 2.3% PVP K-30 and 16.6% SDS. The aqueous concentrate was diluted at 3.6/100 and 1.9/100 to produce optically clear, ready-to-use disinfectant compositions. 2-phenylphenol in these compositions was in the nanoparticle range.

### EXAMPLE 18

### Propiconazole-PVP K-30-Sodium Lauryl Sulfate

Preparation of 8% Propiconazole formulation: 1 g of a 33% aqueous solution of polyvinylpyrrolidone (PVP K-30) was added to a 100 ml stoppered glass bottle, the sample was then diluted with the addition of 6.2 g of purified water and hand shaken until the aqueous solution was homogeneous. 9.6 g of Sodium Lauryl Sulfate (Stepanol WAC, (29% aqueous solution, from Stepan)) was added to this aqueous solution with further shaking the sample to form a premix that was clear, and homogeneous. 0.46 g of Miconazole was weighed and added in a 20 ml container. 5.27 g of the above premix was then added to the 20 ml container containing Propiconazole. The sample was shaken and put on a rotary mixer overnight, to produce a clear, homogeneous disinfectant concentrate. The aqueous concentrate was diluted at dilution ratio of 1/10, 1/50 and 1/100 with purified water. These dilutions were shaken and left to equilibrate overnight. Optically clear, ready-to-use fungicide compositions were obtained.

### EXAMPLE 19

### Miconazole-PVP K-30-Sodium Methyl-2-Sulfolaurate (Alpha Step MC-48)

Preparation of 2% Miconazole formulation: 3 g of a 33% aqueous solution of polyvinylpyrrolidone (PVP K-30) was added to a 100 ml stoppered glass bottle, the sample was then diluted with the addition of 26.4 gm of purified water and hand shaken until the aqueous solution was homogeneous. 19.6 g of Sodium Methyl-2-Sulfolaurate (Alpha Step MC-48, (39% aqueous solution, from Stepan)) was added to this aqueous solution with further shaking the sample to form a premix that was clear, and homogeneous. 0.5 g of Miconazole was weighed and added in a 30 ml container. 24.5 g of the above premix was then added to the 30 ml container containing Miconazole. The sample was shaken and put on a rotary mixer overnight, to produce a clear, homogeneous disinfectant concentrate. The aqueous concentrate was diluted at dilution ratio of 1/10, 1/20 and 1/100 with purified water. These dilutions were shaken and left to equilibrate overnight. Optically clear, ready-to-use fungicide compositions were obtained.

### EXAMPLE 20

### Chlorohexidine—PVP-SDS

Preparation of 2.25% Chlorhexidine formulation: 1.9 g of a 33% aqueous solution of polyvinylpyrrolidone (PVP K-30) was added to a 50 ml stoppered glass bottle, the sample was then diluted with the addition of 12.56 g of purified water and hand shaken until the aqueous solution was homogeneous. 15.5 g of Sodium Lauryl Sulfate aqueous solution (Stepanol WAC, (29% aqueous solution, from Stepan)) was added to this aqueous solution with further shaking the sample to form a premix that was clear, and homogeneous. 0.22 g of Chlorhexidine was weighed and added in a 20 ml container. 10 g of the above premix was then added to the 20 ml container containing Chlorhexidine. The sample was shaken and put on a rotary mixer overnight, to produce a clear, homogeneous disinfectant. Similarly, addition of 0.3 g of Chlorhexidine (3% a.i.) in the place of 0.22 g, to 10 g of the above premix matrix produced a clear, thick but flowable disinfectant aqueous solution.

### EXAMPLE 21

### 4-Chloro-3-methylphenol-PVP K-30-SDS

Preparation of 7.2% 4-Chloro-3-methylphenol formulation: 1.18 g of a 33% aqueous solution of polyvinylpyrrolidone (PVP K-30) was added to a 50 ml stoppered glass bottle, the sample was then diluted with the addition of 7.22 g of purified water and hand shaken until the aqueous solution was homogeneous. 10 g of Sodium Lauryl Sulfate aqueous solution (Stepanol WAC, (29% aqueous solution, from Stepan)) was added to this aqueous solution with further shaking the sample to form a premix that was clear, and homogeneous. 0.71 g of 4-Chloro-3-methylphenol was weighed and added in a 20 ml container. 9.2 g of the above premix was then added to the 20 ml container containing 4-Chloro-3-methylphenol. The sample was shaken and put on a rotary mixer overnight, to produce a clear, homogeneous disinfectant concentrate. The concentrate was diluted to 1/100 with water to produce a clear composition containing ˜0.07%

4-Chloro-3-methylphenol.

### EXAMPLE 22

### 12% Essential Oil-2% PVP K-30-SDS

12% of essential oils was formulated as follows: A premix oil was prepared as follows: 12.05 g Thymol, 8.1 g Menthol, 12.45 g Methyl salicylate and 17.4 g Eucalyptol were weighed and added in a 100 ml stoppered glass bottle. The sample was shaken vigorously and it was allowed to stabilize and clear at room temperature.

The matrix was prepared as follows: 0.32 g of a 33% aqueous solution of polyvinylpyrrolidone K-30 was added to a 10 ml vial, the sample was then diluted with the addition of 2.12 g of purified water and hand shaken until the aqueous solution was homogeneous. 2.9 g of Sodium Lauryl Sulfate (Stepanol WAC, (29% aqueous solution, from Stepan)) was added to this aqueous solution with further shaking the sample to form a premix that was clear, and homogeneous.

0.36 g of the premix oil was weighed and added in a 5 ml container. 2.66 g of the above matrix was then added to the 5 ml container containing the premix oil. The sample was shaken and put on a rotary mixer overnight, to produce a clear, homogeneous concentrate. The aqueous concentrate was diluted at dilution ratio of 1/22 and 1/43 and 1/86 with purified water. These dilutions were shaken and left to equilibrate overnight. Optically clear, ready-to-use compositions containing 0.51%, 0.27%, and 0.13% essential oil were obtained. The above compositions can be used as a water based mouth wash disinfectant base-matrix composition. Additional components like flavor (Vanilla), oxidizing agents (like peroxide), nutrients like Fluoride can be introduced in the above disinfecting base-matrix.

### EXAMPLE 23

### 12% Essential Oil—SDS

### Comparative Example

The matrix was prepared as follows, 5.1 g of Sodium Lauryl Sulfate (Stepanol WAC, (29% aqueous solution, from Stepan)) was added to a 10 ml vial, the sample was then diluted with the addition of 3.7 g of purified water and hand shaken until the aqueous solution was homogeneous.

0.62 g of the premix oil in Example 22 was weighed and added in a 10 ml vial. 4.4 g of the above matrix was then added to the 10 ml container containing the premix oil. The sample was shaken and put on a rotary mixer overnight, to produce a clear, homogeneous concentrate. The aqueous concentrate was diluted at dilution ratio of 1/22, 1/45, and 1/90 with purified water providing a composition of 0.53% 0.26%, and 0.13% essential oil in the dilution. These dilutions were shaken and left to equilibrate overnight, producing cloudy compositions.

### EXAMPLE 24

### 15% Essential Oil—3.5% PVP K-30-SDS

The matrix was prepared as follows, 1 g of a 33% aqueous solution of polyvinylpyrrolidone K-30 was added to a 10 ml vial, the sample was then diluted with the addition of 3 g of purified water and hand shaken until the aqueous solution was homogeneous. 4.6 g of Sodium Lauryl Sulfate (Stepanol WAC, (29% aqueous solution, from Stepan)) was added to this aqueous solution with further shaking the sample to form a premix that was clear, and homogeneous.

0.65 g of the premix oil in Example 22 was weighed and added in a 10 ml vial. 4.35 g of the above matrix was then added to the 10 ml container containing the premix oil. The sample was shaken and put on a rotary mixer overnight, to produce a clear, homogeneous concentrate. The aqueous concentrate was diluted at dilution ratio of 1/49 with purified water. The diluted composition was shaken and left to equilibrate overnight. Optically clear, ready-to-use aqueous composition containing 0.26% essential oil was obtained.

### EXAMPLE 25

### 15% Essential Oil—SDS

### Comparative Example

The matrix was prepared as follows, 2.25 g of Sodium Lauryl Sulfate (Stepanol WAC, (29% aqueous solution, from Stepan)) was added to a 20 ml vial, the sample was then diluted with the addition of 10.6 g of purified water and hand shaken until the aqueous solution was homogeneous.

0.76 g of the premix oil in Example 22 was weighed and added in a 10 ml vial. 4.31 g of the above matrix was then added to the 10 ml container containing the premix oil. The sample was shaken and put on a rotary mixer overnight, to produce a clear, homogeneous concentrate. The aqueous concentrate was diluted at dilution ratio of 1/27 and 1/54 with purified water providing a composition of 0.52% and 0.27% essential oil in the dilution. These dilutions were shaken and left to equilibrate overnight, producing cloudy compositions.

### EXAMPLE 26

### 15% Essential Oil—5% PVP K-30-SDS

The matrix was prepared as follows, 2.3 g of a 33% aqueous solution of polyvinylpyrrolidone K-30 was added to a 20 ml vial, the sample was then diluted with the addition of 3.77 g of purified water and hand shaken until the aqueous solution was homogeneous. 6.6 g of Sodium Lauryl Sulfate (Stepanol WAC, (29% aqueous solution, from Stepan)) was added to this aqueous solution with further shaking the sample to form a premix that was clear, and homogeneous.

0.75 g of the premix oil in Example 22 was weighed and added in a 10 ml vial. 4.25 g of the above matrix was then added to the 10 ml container containing the premix oil. The sample was shaken and put on a rotary mixer overnight, to produce a cloudy concentrate that was stable for at least 8 days. The aqueous concentrate was diluted at dilution ratio of 1/57 and 1/29 with purified water. These dilutions were shaken and left to equilibrate overnight. Optically clear, ready-to-use compositions containing 0.26% and 0.50% essential oil was obtained.

### EXAMPLE 27

### Miconazole-PVP K-30—Sodium Lauryl Sulfate

Preparation of 2.5% Miconazole formulation: 0.5 g of a 33% aqueous solution of polyvinylpyrrolidone K-30) was added to a 50 ml stopper glass bottle, the sample was then diluted with the addition of 24 g of purified water and hand shaken until the aqueous solution was homogeneous. 4.6 g of Sodium Lauryl Sulfate (Stepanol WAC, (29% aqueous solution, from Stepan)) was added to this aqueous solution with further shaking the sample to form a premix that was clear, and homogeneous. 0.25 g of Miconazole was weighed and added in a 20 ml vial. 9.6 g of the above premix was then added to the 20 ml container containing Miconazole. The sample was shaken and put on a rotary mixer overnight, to produce a clear, homogeneous disinfectant concentrate. The aqueous concentrate was diluted at dilution ratio of 1/5, and 1/50 with purified water. These dilutions were shaken and left to equilibrate overnight. Optically clear, ready-to-use fungicide compositions were obtained.

### EXAMPLE 28

### Atorvastatin Calcium—PVP K-30—Sodium Lauryl Sulfate

Preparation of 0.8% Atorvastatin Calcium formulation: 1.16 g of a 33% aqueous solution of polyvinylpyrrolidone K-30) was added to a 20 ml vial, the sample was then diluted with the addition of 13 g of purified water and hand shaken until the aqueous solution was homogeneous. 0.18 g of Sodium Lauryl Sulfate (Stepanol WAC, (29% aqueous solution, from Stepan)) was added to this aqueous solution with further shaking the sample to form a premix that was clear, and homogeneous. 0.04 g of Atorvastatin Calcium was weighed and added in a 10 ml vial. 4.4 g of the above premix was then added to the 10 ml container containing Atorvastatin Calcium. The sample was shaken and put on a rotary mixer overnight, to produce a clear and homogeneous aqueous composition.

This composition is viable as an aqueous delivery of a water insoluble drug like Atorvastatin Calcium.

### EXAMPLE 29

### IPBC-PVP K-30—Sodium Lauryl Sulfate

Preparation of 1% IPBC formulation: 1.8 g of a 33% aqueous solution of polyvinylpyrrolidone K-30) was added to a 50 ml stopper glass container, the sample was then diluted with the addition of 12 g of purified water and hand shaken until the aqueous solution was homogeneous. 0.16 g of Sodium Lauryl Sulfate (Stepanol WAC, (29% aqueous solution, from Stepan)) was added to this aqueous solution with further shaking the sample to form a premix that was clear, and homogeneous. 0.11 g of IPBC was weighed and added in a 20 ml vial. 9.4 g of the above premix was then added to the 20 ml container containing IPBC. The sample was shaken and put on a rotary mixer overnight, to produce a clear and homogeneous concentrate. The aqueous concentrate was diluted at dilution ratio of 1/10, 1/50 and 1/75 with purified water to produce optically clear, ready-to-use compositions.

### EXAMPLE 30

1% Ferullic acid was dissolved in water containing, by weight, 2.8% PVP K-30 and 6.3% SDS. The aqueous solution was optically clear and in the nano-particle range

### EXAMPLE 31

### PCMX-PVP K-30-Sodium Methyl-2-Sulfolaurate (Alpha Step PC-48)

Preparation of 2% PCMX (p-chloro-m-xylenol) formulation: 2.21 g of a 33% aqueous solution of polyvinylpyrrolidone K-30 was added to a 50 ml stopper glass bottle, the sample was then diluted with the addition of 30.71 gm of purified water and hand shaken to form a homogeneous aqueous solution. 6.27 g of Sodium Methyl-2-Sulfolaurate (Alpha Step PC-48, (38% aqueous solution, from Stepan)) was added to this aqueous solution with further shaking the sample to form a premix that was clear, and homogeneous. 0.4 g of PCMX was weighed and added in a 30 ml container. 19.6 g of the above premix was then added to the 30 ml container with PCMX to form a disinfectant aqueous solution. The sample was shaken and put on a rotary mixer overnight, to produce a clear, homogeneous concentrate. The aqueous concentrate was diluted at dilution ratio of 1/10, 1/20, 1/100 and 1/450 with purified water. These dilutions were shaken and left to equilibrate overnight. Optically clear, ready-to-use disinfectant compositions were obtained and found to be stable for more than 2 weeks of observation.

### EXAMPLE 32

### OPP-PVP K-30-Sodium Methyl-2-Sulfolaurate (Alpha Step MC-48)

Preparation of 2.5% O-phenylphenol formulation: 2.2 g of a 33% aqueous solution of polyvinylpyrrolidone K-30 was added to a 50 ml stoppered glass bottle, the sample was then diluted with the addition of 21.2 gm of purified water and hand shaken until the aqueous solution was homogeneous. 15.8 g of Sodium Methyl-2-Sulfolaurate (Alpha Step MC-48, (39% aqueous solution, from Stepan)) was added to this aqueous solution with further shaking the sample to form a premix that was clear, and homogeneous. 0.5 g of O-phenylphenol was weighed and added in a 30 ml container. 19.5 g of the above premix was then added to the 30 ml container containing O-phenylphenol. The sample was shaken and put on a rotary mixer overnight, to produce a clear, homogeneous disinfectant concentrate. The aqueous concentrate was diluted at dilution ratio of 1/10, 1/20 and 1/100 with purified water. These dilutions were shaken and left to equilibrate overnight. Optically clear, ready-to-use disinfectant compositions were obtained and found to be stable for more than 4 weeks of observation.

### EXAMPLE 33

### O-phenylphenol-O-benzylchlorophenol-PVP K-30-SDS

Preparation of 2.9% O-phenylphenol and 2.65 O-benzylchlorophenol formulation: 1.8 g of a 33% aqueous solution of polyvinylpyrrolidone K-30 was added to a 50 ml stopper glass bottle, the sample was then diluted with the addition of 23.5 g of purified water and hand shaken until the aqueous solution was homogeneous. 15.5 g of Sodium Lauryl Sulfate aqueous solution (Stepanol WAC, (29% aqueous solution, from Stepan)) was added to this aqueous solution with further shaking the sample to form a premix that was clear, and homogeneous. 0.44 g O-phenylphenol and 0.4 g O-benzylchlorophenol were weighed and added in a 20 ml container. 14.3 g of the above premix was also added to the 20 ml container containing O-phenylphenol and O-benzylchlorophenol. The sample was shaken and put on a rotary mixer overnight, to produce a viscous milky emulsion concentrate. This concentrate was diluted with purified water at ratio of 1/48.9, 1/100, 1/184, 1/337 producing a clear bluish solution at all dilutions except at 1/48.9 ratio. At 1/48.9 ratio the diluted solution was hazy bluish. All samples remained stable for over 160 days at room temperature.

### EXAMPLE 34

### O-phenylphenol-O-benzylchlorophenol-PVP K-30-SDS

Preparation of 5.5% O-phenylphenol and 2.5 O-benzylchlorophenol formulation: 1.8 g of a 33% aqueous solution of polyvinylpyrrolidone K-30 was added to a 50 ml stopper glass bottle, the sample was then diluted with the addition of 22.8 g of purified water and hand shaken until the aqueous solution was homogeneous. 15.1 g of Sodium Lauryl Sulfate aqueous solution (Stepanol WAC, (29% aqueous solution, from Stepan)) was added to this aqueous solution with further shaking the sample to form a premix that was clear, and homogeneous. 0.83 g O-phenylphenol and 0.38 g O-benzylchlorophenol were weighed and added in a 20 ml vial. 13.9 g of the above premix was also added to the 20 ml container containing O-phenylphenol and O-benzylchlorophenol. The sample was shaken and put on a rotary mixer overnight, to produce a viscous milky emulsion concentrate that was stable for at least 160 days. This concentrate was diluted with purified water at ratio of 1/48.9, 1/95, 1/192, 1/406 producing a clear bluish solution at all dilutions except at 1/48.9 ratio. At 1/48.9 ratio the diluted solution was hazy bluish. All samples remained stable for over 160 days at room temperature.

### EXAMPLE 35

### PVP K-30—SDS—Gafquat HS-100

Preparation of PVP K-30, SDS matrix with cationic polymer (Gafquat HS-100): 6 g of 33% aqueous solution of polyvinylpyrrolidone K-30 was added to a 100 ml stopper glass bottle, the sample was then diluted with the addition of 29 g of purified water and hand shaken until the aqueous solution was homogeneous. 48.2 g of Sodium Lauryl Sulfate aqueous solution (Stepanol WAC, (29% aqueous solution, from Stepan)) was added to this aqueous solution with further shaking the sample to form a premix that was clear, and homogeneous. 5 g of Gafquat HS-100 (Vinyl Pyrrolidone/Methacrylamidopropyl Trimethylammonium Chloride Copolymer, 20% aqueous solution) was added to the above mixture and hand-shaken thoroughly. The sample was clear and no precipitate was observed.

### EXAMPLE 36

Example 35 was repeated using 5 g of Gafquat 755N (Quaternized Vinyl Pyrrolidone/Dimethylaminoethyl Methacrylate/ethyl sulfate Copolymer, 20% aqueous solution) was used in the place of Gafquat HS-100. Similar results were obtained.

### EXAMPLE 37

### PCMX-PVP K-30-SDS (1:8) Powder

Preparation of 22.73% PCMX powder formulation: 2.88 g of polyvinylpyrrolidone K-30 powder was mixed with 21.6 g of Sodium Lauryl Sulfate powder (Aldrich) in a 50 ml bottle by hand shaking the powder mixture. 7.2 g of PCMX was weighed and added to the container with powder and handshaken. The mixture was then transferred to a ScienceWare Micro-mill from Bel-Arts Products and mixed further for 2 minutes. 0.53 g of the mixed sample was added to a beaker containing 49.5 g of purified water to produce a concentration of 0.24% PCMX in solution. A magnetic stirrer was added to the beaker and placed onto a stirring plate where it was stirred at moderately fast rate (minimum level for the stirrer). Within 10 minutes most of the PCMX solid was observed to dissolve. Within 20 minutes about 95% of the PCMX solid was dissolved, and within 45 minutes there was no particles present.

### EXAMPLE 38

### PCMX-PVP K-30-SDS (1:1) Powder

Preparation of 14.2% PCMX powder formulation in a mixture of 1 to 1 PVP K-30: SDS: 4.2 g of polyvinylpyrrolidone K-30 powder was mixed with 4.2 g of Sodium lauryl sulfate powder (Aldrich) in a 50 ml bottle by hand shaking the powder mixture. 1.39 g of PCMX was weighed and added to the container with powder and hand-shaken. The mixture was then transferred to a ScienceWare Micro-mill from Bel-Arts Products and mixed further for 2 minutes. 0.85 g of the mixed sample was added to a beaker containing 48.9 g of purified water to produce a concentration of 0.24% PCMX in solution. A magnetic stirrer was added to the beaker and placed onto a stirring plate where it was stirred at moderately fast rate (minimum level for the stirrer), similar to Example 37. Compositions of Example 37 and Example 38 (this example) were stirred side by side for comparison. Within 10 minutes, most of the PCMX solid was observed to dissolve, the amount of solid PCMX in solution was observed qualitatively to be lower in Example 37 compared to the present Example. Within 20 minutes about 95% of the PCMX solid was dissolved, and within 45 minutes there was no particles present. During stirring, composition of Example 37 also showed a persistent, higher level of foaming, compared to the present Example.

### EXAMPLE 39

0.53 g of the milled solid composition of Example 37 was mixed with 100 g of water and the charge was freeze-dried to produce a solid composition containing ˜22.5% PCMX. The solid dissolved in water at 0.24% PCMX more easily than the starting composition from Example 37.

### EXAMPLE 40

Example 39 was repeated with starting composition of Example 38. The resulting freeze-dried solid contained ˜14% PCMX. The solid dissolved to a clear homogeneous solution more easily than the starting composition prior to freeze-drying.

### EXAMPLE 41

Example 40 was repeated replacing freeze-drying step by spray drying in a laboratory model Spray drier. Similar results were obtained in dissolution of the PCMX.

### EXAMPLE 42

### Tablet

15.9 g of the milled solid composition of Example 37 was mixed with 2 g Disintex 200 (Swellable polyvinylpyrrolidone, ISP) and 10 g of microprill urea in a v-blender for 30 minutes. The powder was poured in a 4 cm dye and pressed with a force of 0.7 tons for 1 second (Carver, Inc instrument model 2946) to produce a tablet containing ˜12.9% PCMX. The tablet was put onto a porous cage and was submerged at 2 inches below the surface in 1.5 liter of water under constant stirring using a 2 liter beaker. The tablet dissolved in less than 10 minutes making a solution of 0.24% PCMX.

### EXAMPLE 43

### Compatibility of Peroxide with Essential Oil Composition of Example 22

10% Essential Oil-1.9% PVP K-30-SDS

The matrix was prepared as follows, 1.14 g of a 33% aqueous solution of polyvinylpyrrolidone K-30) was added to a 50 ml vial, the sample was then diluted with the addition of 7.07 g of purified water and hand shaken until the aqueous solution was homogeneous. 1.14 g of Sodium Lauryl Sulfate (Stepanol WAC, (29% aqueous solution, from Stepan)) was added to this aqueous solution with further shaking the sample to form a premix that was clear, and homogeneous. 2.4 g of the premix oil in Example 22 was weighed and added to the 50 ml container containing the premix matrix. The sample was shaken to produce a clear concentrate after standing overnight. 0.39 g of the concentrate was mixed with a solution containing with 0.61 g of 30% aqueous hydrogen peroxide (Aldrich) and 14.06 g of water. Thus obtaining a solution with 0.26% essential oil and 1.2% hydrogen peroxide. The diluted solution was hand-shaken and was clear and homogeneous.

### EXAMPLE 44

### Compatibility of PCMX Ready-to-Use Aqueous Composition with Acids—Citric Acid

### pH of 0.24% PCMX-PVP-SDS-Citric Acid

6.1 g of a 33% aqueous solution of polyvinylpyrrolidone K-30) was added to a 100 ml stopper glass bottle, the sample was then diluted with the addition of 42.3 g of purified water and hand shaken to form a homogeneous aqueous solution. 51.6 g of Sodium Lauryl Sulfate (Stepanol WAC, 29% aqueous solution), was added to this aqueous solution with further shaking the sample to form a premix that was clear, and homogeneous. 5 g of PCMX was weighed and added to the above premix to form a disinfectant aqueous solution. The sample was shaken and put on a rotary mixer overnight, to produce a clear, homogeneous concentrate. 25 grams of the concentrate was diluted to 500 g with purified water obtaining a clear aqueous solution of f0.25% PCMX.

100 grams of the diluted solution was titrated with a solution containing 10% citric acid (Aldrich, ACS reagent grade). The pH of the solution was measured at various intervals during the titration and is given in the table below. Throughout the titration, the solution was remained clear.

pH of dilute solution in Example 44 vs ml of titrant (10%
citric acid)

| ml titrant | pH |
|---|---|
| 0.0 | 7.1 |
| 0.25 | 3.56 |
| 0.50 | 3.18 |
| 0.60 | 3.06 |
| 0.75 | 2.94 |
| 1.05 | 2.86 |
| 1.25 | 2.79 |
| 1.50 | 2.74 |
| 1.75 | 2.69 |
| 2.0 | 2.63 |
| 2.5 | 2.59 |
| 3.0 | 2.54 |
| 3.5 | 2.5 |
| 4.0 | 2.45 |

### EXAMPLE 45

0.2 g of citric acid powder (Aldrich, ACS reagent grade) was added to 5 g of PCMX concentrate from example 44. The sample was shaken and put on a rotary mixer overnight, to produce a clear, homogeneous concentrate. The pH of the concentrate at 1/10 dilution was 2.67. The concentrate on dilution to levels: 1/10, 1/20, 1/40, 1/80, and 1/100 were clear.

### EXAMPLE 46

### pH of 0.24% PCMX-PVP-SDS-Sodium Bicarbonate [Compatibility of PCMX Ready-to-Use Aqueous Composition with Base-Sodium Bicarbonate]

100 grams of the diluted solution containing 0.24% PCMX in Example 44 was titrated with a solution containing 5% sodium bicarbonate (Aldrich, ACS reagent grade). The pH of the solution was measured at various intervals during the titration and is given in the table below. Throughout the titration, the solution was remained clear.

pH of dilute solution in Example 45 vs ml of titrant (5% sodium
bicarbonate)

| ml titrant | pH |
|---|---|
| 0.0 | 7.18 |
| 0.2 | 7.66 |
| 0.4 | 7.91 |
| 0.6 | 7.97 |
| 0.8 | 8.06 |
| 1.3 | 8.12 |
| 1.5 | 8.2 |
| 2.0 | 8.24 |
| 2.5 | 8.29 |

### EXAMPLE 47

1.7 g of peracetic acid solution (Fluka, ˜39% (RT) in acetic acid) was added to 8.3 grams of PCMX concentrate from example 16. The sample was hand-shaken to produce a stable concentrate containing 4% PCMX and 6.6% peracetic acid that was clear with a yellow color. 1 g of this concentrate was diluted to 17 g with purified water which produced a solution with 0.24% PCMX and 0.39% peracetic acid (an equivalent of 0.17% hydrogen peroxide). The diluted solution was clear with a tint of yellow color. The pH of the sample was measured at 2.8 as compared to pH 8.1 in the absence of Per acetic acid.

### EXAMPLE 48

### 5% PCMX-9.5% PVP K-30-9.5% SDS

1.67 g PCMX was dissolved in an aqueous solution containing, by weight, 3.1 g SDS (Aldrich, reagent grade), 3.1 g PVP K-30 (ISP, Powder) and 25.3 g of purified water. The concentrate was low foaming and flowable with a water-like viscosity. This clear aqueous concentrate was diluted at 1/20.8 to produce optically clear, ready-to-use disinfectant composition containing 0.24% PCMX.

### EXAMPLE 49

### 10% Essential Oil-2% PVP K-30-SDS-NaF-Peroxide

10% of essential oils was formulated as follows: 2 g of the premixed oil in Example 22 was added to 18 grams of the matrix also from Example 22 in a 20 ml vial. The sample was hand-shaken to produce a clear concentrate. A dilute solution containing 0.26% essential oil mixture was prepared by diluting 2.61 g of the concentrate with 96.82 g of purified water. The sample was hand shaken. 0.52 g of peroxide solution (30% solution, Aldrich) and 0.052 g of sodium fluoride (Aldrich, reagent grade) were also added to the dilute solution. The sample was hand-shaken again to make a clear ready to use solution.

### EXAMPLE 50

### Propyl Paraben, PVP K-30, SDS

3 g propyl paraben was dissolved in an aqueous solution containing, by weight, 15.3 g SDS and 2 g PVP K-30 and 79.7 g of water. The formulated concentrate was clear. This clear aqueous concentrate was diluted at 1/29.6, 1/15.1, 1/7.5, and 1/3.75 with purified water to produce optically clear, ready-to-use composition containing 0.1%, 0.2%, 0.4% and 0.8% propylparaben. When propylparaben was replaced by either 3 g ethylparaben or 3 g methylparaben clear solutions were also obtained in concentrate and dilutions as described above.

While the invention has been described with particular reference to certain embodiments thereof, it will be understood that changes and modifications may be made which are within the skill of the art.

What is claimed is:

1. An aqueous composition comprising an aqueous nanoparticle dispersion or emulsion of a hydrophobic material and a water soluble matrix of (a) a water soluble polymer, and (b) a water soluble surfactant wherein (a) and (b) interact to form a complex having a lower critical micelle concentration (cmc) than a control composition without the water soluble polymer.

2. An aqueous composition according to claim 1 wherein said composition is optically clear.

3. An aqueous composition according to claim 1 wherein the weight ratio of hydrophobic material to (a) is 1:10 to 5:0.5.

4. An aqueous composition according to claim 3 wherein said ratio is 1:0.2 to 1:2.

5. An aqueous composition according to claim 1 wherein the weight ratio of hydrophobic material to (b) is 1:10 to 5:1.

6. An aqueous composition according to claim 5 wherein said ratio is 1:3 to 1:5.

7. An aqueous composition according to claim 1 wherein the weight ratio of (a):(b) is 20:1 to 1:20.

8. An aqueous composition according to claim 1 wherein said hydrophobic material comprises a bioactive material.

9. An aqueous composition according to claim 8 wherein said bioactive material comprises a water-insoluble organic compound selected from the group consisting of a biocide, fungicide, bactericide, insecticide, herbicide, algicide, disinfectant, light stabilizer, UV absorber, hydrocarbon, radical scavenger, synthetic resin, essential oil, natural wax compound and mixtures thereof.

10. An aqueous composition according to claim 9 wherein said bioactive material comprises a disinfectant selected from the group consisting of triclosan, chlorhexidine, iodopropargyl butyl carbamate (IPBC), orthophenyl phenol, parachlorometaxylenol (PCMX), parachloro ortho benzyl phenol, pine oil, mixed phenol disinfectants, mixed phenol, quats and mixtures thereof.

11. An aqueous composition according to claim 10 wherein said disinfectant is triclosan.

12. A use composition comprising the aqueous composition of claim 1 and water of dilution.

13. A use composition according to claim 12 wherein said hydrophobic material is present in an amount of 10 ppm to 40% by weight in said use composition.

14. A use composition according to claim 13 wherein said hydrophobic material is present in an amount of 0.05 to 0.5%.

15. A use composition according to claim 12 in which said hydrophobic mixture is present in a toothpaste or mouthwash.

16. A use composition according to claim 12 wherein said use composition further comprises one or more additives selected from the group consisting of flavors, colors, thickeners, defoamers, additional polymers.

17. A method for forming an aqueous composition containing a nanoemulsion or nanodispersion of a hydrophobic material comprising:
providing a water soluble matrix of (a) a water soluble polymer, and (b) a surfactant wherein (a) and (b) interact to form a complex having a lower critical micelle concentration (cmc) than a control composition without the water soluble polymer, and
combining said water soluble matrix with a hydrophobic material to form an aqueous composition containing a nanoemulsion or nanodispersion of the hydrophobic material.

18. A method according to claim 17 wherein said composition is optically clear.

19. A method according to claim 17 wherein the weight ratio of hydrophobic material to (a) is 1:10 to 5:0.5.

20. A method according to claim 19 wherein said ratio is 1:0.2 to 1:2.

21. A solid composition comprising a hydrophobic material and a water soluble matrix of (a) a water soluble polymer, and (b) a water soluble surfactant wherein (a) and (b) interact to form a complex having a lower critical micelle concentration (cmc) than a control composition without the water soluble polymer.
